(19) United States
(12) Patent Application Publication
(10) Pub. No.: US 2024/0235969 A9
(43) Pub. Date: Jul. 11, 2024

(54) DATA TRANSMISSION METHOD AND DATA TRANSMISSION SYSTEM

(71) Applicant: WASEDA UNIVERSITY, Tokyo (JP)

(72) Inventors: Yutaka KATSUYAMA, Tokyo (JP); Toshio SATO, Tokyo (JP); Kazuhiko TAMESUE, Tokyo (JP); Takuro SATO, Tokyo (JP); Jiro KATTO, Tokyo (JP)

(21) Appl. No.: 18/473,531

(22) Filed: Sep. 25, 2023

(30) Foreign Application Priority Data
Sep. 27, 2022 (JP) 2022-154191

(51) Int. Cl. H04L 43/067; H04L 41/16; H04L 43/106

(52) U.S. Cl. CPC H04L 43/067; H04L 41/16; H04L 43/106

(57) ABSTRACT

A system for transmitting data via a network with a transmission latency includes: a transmitting device configured to sequentially transmit data; a data prediction device configured to predict future data after a lapse of a prediction time equivalent to a latency time on a transmission line of the network based on time-series data in a given period transmitted from the transmitting device, using a prescribed prediction method, and transmit the future data; and a receiving device configured to receive the future data.

### CROSS-REFERENCE TO RELATED APPLICATIONS

The present application claims priority to Japanese Patent Application No. 2022-154191 filed on Sep. 27, 2022, the contents of which are incorporated herein by reference in their entirety.

### TECHNICAL FIELD

The present invention relates to a data transmission method and a data transmission system for transmitting data via a network with a transmission latency.

### BACKGROUND ART

In recent years, various techniques for transmitting data to a remote location via a network have been proposed. For example, Patent Literature 1 discloses a system in which a camera captures images of a machine in a remote welding site and an operator in a local site remotely operates the machine while watching the images on a monitor. Patent Literature 2 discloses a technique for a data streaming system that divides data to be streamed and determines a destination and a delivery time in a planned way. When the system judges that a latency on a transmission line is large, the streaming is performed prior to the planned data delivery time, which eliminates the data latency on a receiving end.

Patent Literature 3 discloses a remote control system that enables a user to operate an operation device by presenting to the user a contact force detected by a contact force sensor provided on a remote robot, concurrently with displaying captured images of the remote robot on a monitor near the user. In this remote control system, if there is a time difference between displaying the images and presenting the contact force due to a transmission latency, the user develops a feeling of strangeness. To reduce the feeling of strangeness, the system delays the motion control of at least one of the robot and the operation device.

Patent Literature 4 discloses a remotely controllable automated driving system in which a remote operation device transmits a control signal to a vehicle and the vehicle returns the received control signal and transmits video footage. The remote operation device calculates movement of the vehicle based on a difference between the control signal transmitted to the vehicle and the control signal returned from the vehicle, and displays information indicating the movement of the vehicle such that the information is superimposed on the video footage received from the vehicle.

### CITATION LIST

### Patent Literature

Patent Literature 1: Japanese Patent Application Laid-Open No. 2019-910
Patent Literature 2: Japanese Patent Application Laid-Open No. 2014-204270
Patent Literature 3: Japanese Patent Application Laid-Open No. 2022-95300
Patent Literature 4: Japanese Patent Application Laid-Open No. 2021-158507

### SUMMARY OF INVENTION

### Technical Problem

Patent Literature 1 is on the assumption that a latency time on a network connecting between the local site and the remote site is sufficiently short, and thus the technique of Patent Literature 1 cannot be applied to data transmission via a network with a relatively large transmission latency. In Patent Literature 2, since the content of data to be streamed is determined in advance, the streaming is performed prior to the scheduled delivery time when a latency on a communication path is expected, which makes it possible to realize a low-latency reception on the receiving end. However, in general communication in which the content of data to be streamed is not determined in advance, it seems impossible to use the technique of Patent Literature 2. The techniques of Patent Literature 3 and Patent Literature 4 are not intended to eliminate a data transmission latency.

The invention has been made in view of the foregoing, and an object of the invention is to provide a data transmission method and a data transmission system for realizing a low-latency data transmission.

### Solution to Problem

A data transmission method according to the invention is a method for transmitting data via a network with a transmission latency. The method includes: sequentially transmitting data by a transmitting device; predicting future data after a lapse of a prediction time equivalent to a latency time on a transmission line of the network based on time-series data in a given period transmitted from the transmitting device, by a data prediction device using a prescribed prediction method; transmitting the future data by the data prediction device; and receiving the future data by a receiving device.

A data transmission system according to the invention is a system for transmitting data via a network with a transmission latency. The system includes: a transmitting device configured to sequentially transmit data; a data prediction device configured to predict future data after a lapse of a prediction time equivalent to a latency time on a transmission line of the network based on time-series data in a given period transmitted from the transmitting device, using a prescribed prediction method, and transmit the future data; and a receiving device configured to receive the future data.

### Advantageous Effects of Invention

According to the invention, a data prediction device predicts future data after a lapse of a prediction time equivalent to a latency time on a transmission line of a network. With this feature, it is possible to realize data transmission with almost zero latency time between transmitting and receiving ends.

### BRIEF DESCRIPTION OF DRAWINGS

FIG. 1 is a configuration diagram of a data transmission system according to a first embodiment of the invention.

FIG. 2 is a schematic diagram illustrating a training process by a neural network of a data prediction device.

FIG. 3 is a schematic diagram illustrating a process for predicting future data from input data by the neural network of the data prediction device.

FIG. 4 is a configuration diagram of a data transmission system according to a second embodiment of the invention.

FIG. 5 is a configuration diagram of a remote control system for transmitting operating information of a controller to a machine in a remote location, as an example of application of the data transmission systems according to the first and second embodiments.

FIG. 6 is a configuration diagram of a remote control system according to a variation of FIG. 5.

FIG. 7 is a graph illustrating an example of a time change of operating information of a controller and electromyographic information of an operator.

FIG. 8 is a schematic diagram illustrating a multimodal prediction method using operating information of a controller and electromyographic information of an operator.

FIG. 9 is a graph illustrating prediction results of the operating information of the controller obtained by the multimodal prediction method.

FIG. 10 is a schematic diagram illustrating data prediction by a linear prediction method.

### DESCRIPTION OF EMBODIMENTS

Exemplary embodiments of the invention will be described below with reference to the accompanying drawings.

In some kind of real-time communication, a future data content can be predicted from a previously transmitted data content. The embodiments provide data transmission methods and systems which allow almost zero latency time on a receiving end in such data communication by installing a data prediction device on a communication path to predict future data.

### First Embodiment

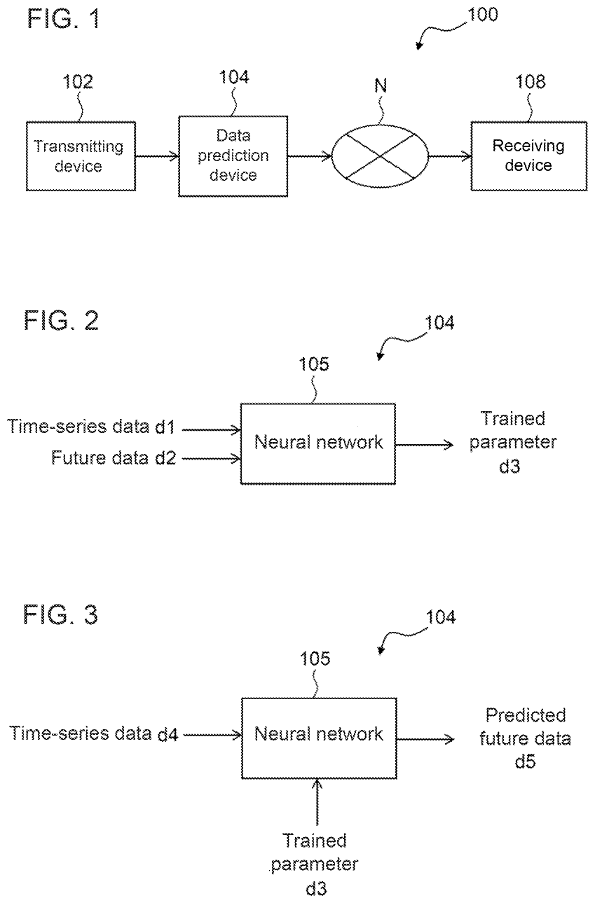

A data transmission system according to a first embodiment of the invention will be described. As shown in FIG. 1, a data transmission system 100 according to the first embodiment is a system for transmitting data to a remote location via a network N, and includes a transmitting device 102, a data prediction device 104, and a receiving device 108.

FIG. 1 shows a case where the data prediction device 104 and the receiving device 108 are connected to each other via the network N and the data prediction device 104 is installed at a transmitting end. However, the data prediction device 104 may be installed at a receiving end (in a remote location) as long as the data prediction device 104 is located between the transmitting device 102 and the receiving device 108.

The network N typically has a transmission latency, and a latency time on a transmission line of the network N is assumed to be constant in the first embodiment. The data prediction device 104 predicts future data after a lapse of a prediction time equivalent to the latency time on the network N based on data sequentially transmitted from the transmitting device 102 (a data prediction method will be described later) and transmits the predicted future data to the receiving device 108. Accordingly, the receiving device 108 can receive data that has practically no transmission latency as compared to the data transmitted from the transmitting device 102.

The data prediction device 104 is a computer including a buffer. The data prediction device 104 accumulates data online after the start of data input from the transmitting device 102 until the buffer is full. When the buffer is full, the data prediction device 104 predicts future data after a lapse of a prediction time Tp from time-series data accumulated in the buffer, and outputs one piece of predicted future data. It takes a given period to accumulate data in the buffer only at the beginning, but thereafter the data in the buffer is sent in a pipeline manner and the data is output one by one. The data prediction device 104 repeats a process of discarding the oldest data in the buffer when next data is input, and predicting and outputting future data after a lapse of the prediction time Tp based on the current time-series data in the buffer. Although the prediction time Tp is the sum of a latency time T2 on the network N and a data accumulation time (buffering time) Tb (Tp=Tb+T2), once the buffer is full, the subsequent data accumulation time is negligibly small (Tp×T2).

As shown in FIGS. 2 and 3, the data prediction device 104 includes a neural network 105. The neural network 105 is a neural network such as a long short-term memory (LSTM) of a recurrent neural network (RNN) that handles time-series data. The neural network 105 performs two processes: training and prediction.

At the time of training, as shown in FIG. 2, the neural network 105 trains a plurality of data sets each having time-series data d1 (reference sample data) in the given period Tb and future data d2 after a lapse of the prediction time Tp from the final time of the given period Tb, obtains internal parameter values of the neural network 105 after the training, and stores the internal parameter values as trained parameters d3 corresponding to the data sets, respectively. The larger the number of the data sets, the better. For example, the training process is performed using several thousands of data sets.

At the time of prediction, as shown in FIG. 3, the neural network 105 first reads out the stored trained parameters d3 to prepare for the prediction process. Then, the neural network 105 predicts future data after a lapse of the prediction time Tp based on time-series data d4 in the given period Tb in the current buffer and the corresponding trained parameter d3, and outputs the predicted future data d5.

### Second Embodiment

Next, a second embodiment of the invention will be described. In the first embodiment described above, the latency time on the transmission line of the network N is fixed, and future data after a lapse of the prediction time Tp equivalent to the latency time is predicted. However, the latency time may change dynamically depending on the situation of the transmission line. Therefore, in the second embodiment, in order to cope with a dynamically changing latency time, a means for detecting the latency time on the transmission line of the network N before transmitting data to the receiving end is provided, thereby also dynamically changing the prediction time Tp accordingly.

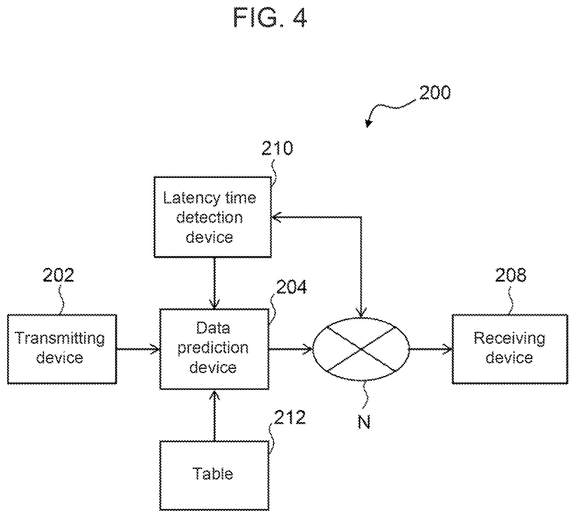

FIG. 4 shows a configuration of a data transmission system 200 according to the second embodiment. The data transmission system 200 includes a transmitting device 202, a data prediction device 204, a receiving device 208, a latency time detection device 210, and a table 212.

The latency time detection device 210 is a computer that calculates a latency time on the transmission line of the network N from a round-trip time of data between the transmitting and receiving ends using a command called “ping”, and outputs the data of the calculated latency time to the data prediction device 204.

As in the first embodiment, the data prediction device 204 includes the neural network 105 (see FIGS. 2 and 3). In order to cope with the dynamically changing latency time on the transmission line, at the time of training, the neural network 105 trains data sets (time-series data d1 and future data d2) for a plurality of different latency times on a one-by-one basis, and obtains a trained parameter d3 for each latency time. The trained parameters d3 for the different latency times are stored in the table 212.

At the time of data transmission, the latency time detection device 210 detects the latency time on the transmission line of the network N before one data packet is sent. The neural network 105 of the data prediction device 204 reads out the trained parameters d3 by referring to the table 212 using the latency time detected by the latency time detection device 210 as a key so as to prepare for the prediction process. Then, the neural network 105 predicts future data after a lapse of the prediction time Tp that is equal to the detected latency time based on the trained parameter d3 corresponding to current time-series data d4 in the buffer, and outputs the predicted future data d5. The predicted future data d5 is transmitted via the network N. Consequently, the receiving device 208 can receive the data with almost no transmission latency.

Note that FIG. 4 shows a case where the data prediction device 204, the latency time detection device 210, and the table 212 are installed at the transmitting end. However, these devices may be installed at the receiving end (in a remote location) as long as they are located between the transmitting device 202 and the receiving device 208.

Next, as an example of application of the data transmission systems according to the first and second embodiments, a remote control system for operating a machine in a remote location using a controller will be described.

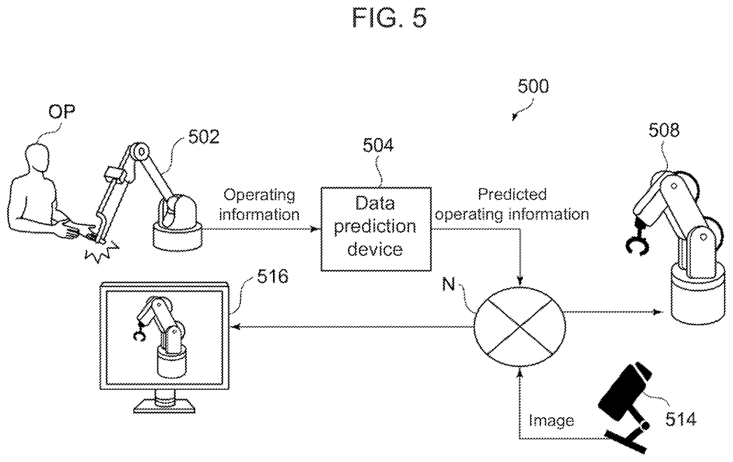

FIG. 5 shows a configuration of a remote control system 500. The remote control system 500 includes a controller 502 as a transmitting device, a data prediction device 504, a machine 508 (such as a robot arm) as a receiving device, a camera 514, and a display 516.

The camera 514 captures images of the machine 508, and the captured images of the machine 508 are transmitted via the network N and displayed on the display 516. An operator OP operates the controller 502 while watching the images of the machine 508 on the display 516, and operating information is sequentially transmitted from the controller 502. The operating information of the controller 502 is, for example, data of three-dimensional coordinate values (X, Y, Z) of a handle portion of the controller 502 according to the operation of the controller 502 (operation in an operable range such as up and down, right and left, and back and forth).

The data prediction device 504 includes the neural network 105 (FIGS. 2 and 3) and predicts future operating information after a lapse of the prediction time Tp based on time-series data of operating information in the given period Tb and the corresponding trained parameter. The predicted future operating information is transmitted to the machine 508 in a remote location via the network N. The machine 508 operates in accordance with the received future operating information.

In the remote control system 500 shown in FIG. 5, the controller 502, the data prediction device 504, the network N, and the machine 508 constitute the data transmission system 100 according to the first embodiment. As in the data transmission system 200 (FIG. 4) according to the second embodiment, the remote control system 500 may include the latency time detection device 210 and the table 212 so as to dynamically change the prediction time Tp in accordance with a dynamically changing latency time on the network N.

Specific examples of the remote control system 500 shown in FIG. 5 include a system in which an operator OP on the earth uses the controller 502 to remotely operate the machine 508 (robot arm) on the lunar surface via the network N. In the communication between the earth and the moon, the latency time T2 on the network N is about one second. Therefore, the data prediction device 504 predicts future operating information after about one second based on the time-series data of operating information in the given period Tb, and outputs the predicted future operating information. By transmitting the future operating information via the network N, the machine 508 can work on the moon at almost the same time as the operation of the controller 502 on the earth.

Since the controller is voluntarily operated by the operator (human), it is difficult to predict a timing at which the controller starts moving by data prediction using only operating information acquired from the controller. It is known that when a human operates a controller manually, his/her muscle is activated before the controller actually starts moving. By taking advantage of this property, it is possible to predict a timing at which the controller starts moving by using not only the operating information of the controller but also electromyographic information of a person who operates the controller at the same time.

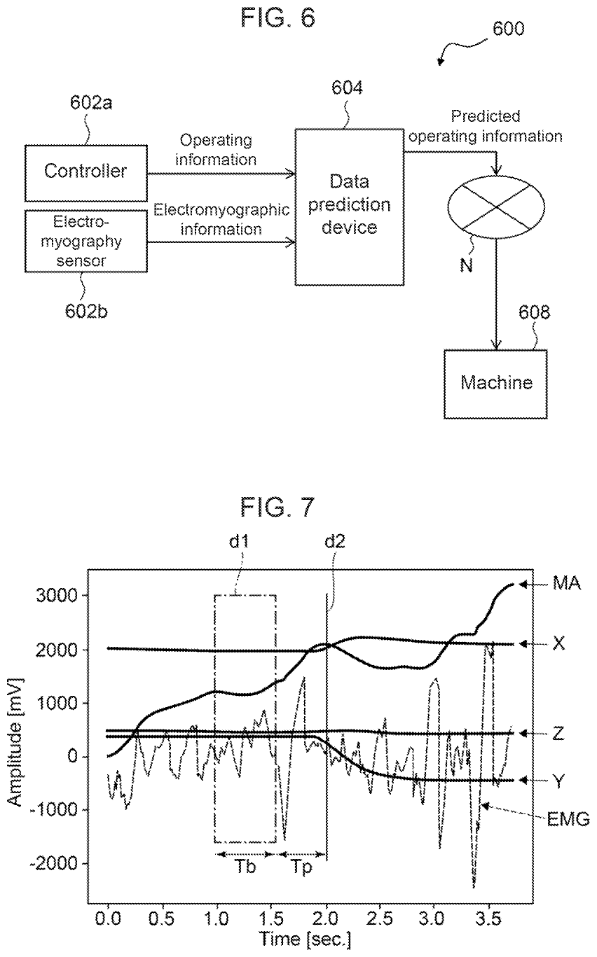

FIG. 6 shows, as a variation of the remote control system 500 of FIG. 5, a configuration of a remote control system 600 that performs a multimodal prediction method using operating information of a controller and electromyographic information of an operator. The remote control system 600 includes a controller 602a, an electromyography sensor 602b, a data prediction device 604, and a machine 608 (such as a robot arm). In FIG. 6, illustrations of a camera that captures images of the machine 608 and a display that displays the images of the machine 608 are omitted.

The controller 602a and the electromyography sensor 602b constitute a transmitting device. The electromyography sensor 602b is attached to near the biceps, triceps, shoulder muscle, or forearm muscle of the operator who grasps a handle of the controller 602a.

FIG. 7 shows an example of time changes of the operating information of the controller 602a and the electromyographic information of the operator who operates the controller 602a. More specifically, FIG. 7 shows experimental data obtained when the operator who wears the electromyography sensor 602b on his/her right biceps moves the controller 602a from right to left (Y direction) with his/her right hand. In FIG. 7, the operating information is expressed as coordinate values (X, Y, Z) of the handle portion of the controller 602a, and the electromyographic information (amplitude (mV)) is expressed as electromyography (EMG) data detected by the electromyography sensor 602b and muscle activity (MA) data obtained based on the electromyography data. A method of transforming electromyography data into muscle activity is explained in, for example, non-patent literature below (page 81).
Sybert Stroeve, “Learning combined feedback and feedforward control of a musculoskeletal system,” Biological Cybernetics 75, p 73-83 (1996).

The data prediction device 604 includes the neural network 105 (see FIGS. 2 and 3). At the time of training, the neural network 105 trains a set of time-series data of coordinate values (X, Y, Z) and muscle activity (MA) in a given period Tb (time-series data d1 in FIG. 7) and data of a coordinate value (X′, Y′, Z′) after a lapse of a prediction time Tp from the final time of the given period Tb (future data d2 in FIG. 7), obtains an internal parameter value of the neural network 105 after the training, and stores the internal parameter value as a trained parameter d3. The neural network 105 repeatedly trains many data sets to obtain the trained parameters d3.

At the time of prediction, the neural network 105 predicts a future coordinate value after a lapse of the prediction time Tp based on the time-series data of coordinate values and muscle activity in the given period Tb (time-series data d4 in FIG. 3) and the trained parameter d3 corresponding to the time-series data d4, and outputs data of the predicted future coordinate value (predicted future data d5 in FIG. 3).

In the example of FIG. 7, the coordinate values (X, Y, Z) are almost constant until a lapse of about 1.9 seconds, and thereafter, the Y coordinate changes rapidly. For this reason, it is difficult to predict a timing at which the controller 602a starts moving by data prediction using only the operating information (coordinate values) of the controller 602a. On the other hand, the muscle activity (MA) starts changing at around 1.3 seconds, indicating that the electromyographic information starts changing 0.5 to 0.6 seconds earlier before the controller 602a actually starts moving. As described above, since the electromyographic information changes prior to the operating information, it is possible to predict the timing at which the controller 602a starts moving by using both the operating information and the electromyographic information.

Note that a plurality of electromyography sensors 602b may be attached to a plurality of areas on the operator's arm and shoulder, and the data prediction may be performed using three-dimensional operating information and a plurality of pieces of electromyographic information.

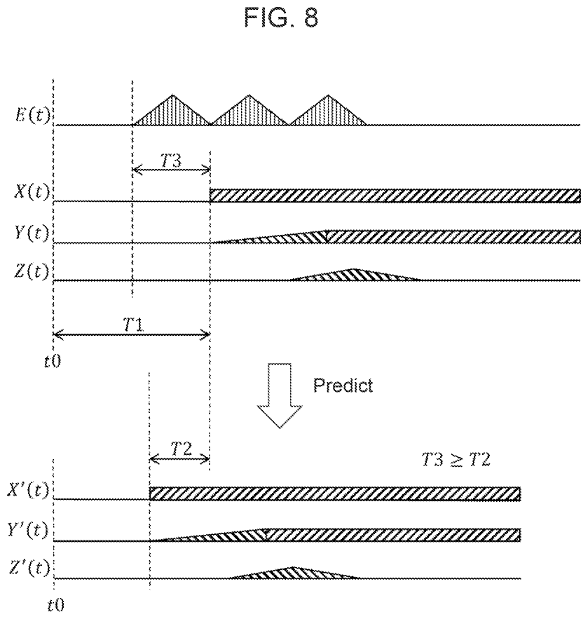

As shown in FIG. 8, assume that the operating information (X(t), Y(t), Z(t)) rises after a lapse of T1 from a reference time t0, and let a difference between rising time of the electromyographic information (E(t)) and rising time of the operating information be denoted by T3. Under the condition that T3 is equal to or greater than the latency time T2 on the network N (T3≥T2), when the prediction time Tp is set to be equal to the latency time T2 (that is, future data after a lapse of T2 is to be predicted), the data prediction device 604 predicts future operating information of the controller 602a after a lapse of (T1−T2) from the reference time t0 and outputs the predicted future operating information (X′(t), Y′(t), Z′(t)). When the future operating information is transmitted to the machine 608 via the network N, the machine 608 starts moving after a lapse of (T1−T2+T2=T1) from the reference time t0 because the latency time on the network N is T2. In this way, it is possible to realize transmission without apparent latency between the transmitting and receiving ends.

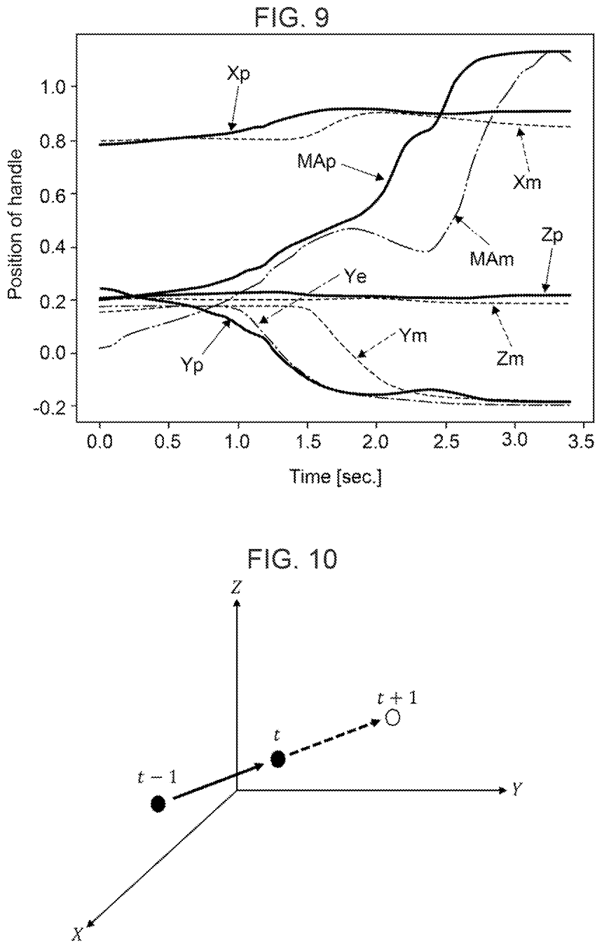

FIG. 9 shows an example of a prediction result of the operating information of the controller 602a when the prediction time Tp is 0.5 seconds. Also in the example of FIG. 9, the operator wears the electromyography sensor 602b on his/her right biceps and moves the controller 602a from right to left (Y direction) with his/her right hand. In FIG. 9, coordinate values (Xm, Ym, Zm) represent measured values of the operating information of the controller 602a, coordinate values (Xp, Yp, Zp) represent predicted values of the operating information of the controller 602a, Ye is an expected value obtained by shifting the value of Ym to the past by the prediction time Tp=0.5 seconds, and MAm and MAp are a measured value and a prediction result of muscle activity, respectively.

Since the controller 602a moves from right to left, the X and Z coordinates show little change, but the Y coordinates change from about +0.18 in right position to about −0.2 in left position. Focusing on the Y coordinates, while the measured value Ym starts changing from a lapse of about 1.5 seconds, the predicted value Yp starts changing from a lapse of around 1.0 second, which means that 0.5 seconds future prediction is realized. In addition, curves of the predicted value Yp and the expected value Ye almost coincide with each other, which means that the prediction of Y coordinates is realized not only around the start of operating the controller 602a, but also in the entire region.

The prediction of the operating information using the electromyographic information shown in FIGS. 6 to 9 is effective when the difference T3 between the rising time of the electromyographic information and the rising time of the operating information is equal to or greater than the latency time T2 on the network N (T3≥T2) (see FIG. 8), but cannot be applied when the latency time T2 on the network N is long and T3<T2 is satisfied. For example, in the communication between the earth and the moon, since the latency time T2 is about 1 second and T3 is usually less than 1 second, operating information cannot be predicted using electromyographic information.

When T3<T2, it is possible to employ the data prediction method using the neural network 105 in which only time-series data of operating information is used as input data as described above. Other data prediction methods for T3<T2 include a linear prediction method, an autoregressive (AR) model for predicting current data from a plurality of pieces of past data, a moving average (MA) model, and an autoregressive integrated moving average (ARIMA) model.

As an example of the data prediction methods, the linear prediction method will be briefly described below with reference to FIG. 10. Let a measured value of a position of the handle portion of the controller at time t−1 be denoted by (Xm(t−1), Ym(t−1), Zm(t−1)) and a measured value of a position of the handle portion at time t be denoted by (Xm(t), Ym(t), Zm(t)). A predicted value of a position of the handle portion at time t+1 (Xp(t+1), Yp(t+1), Zp(t+1)) is given as follows.

Xp(t+1)=Xm(t)+(Xm(t)−Xm(t−1))

Yp(t+1)=Ym(t)+(Ym(t)−Ym(t−1))

Zp(t+1)=Zm(t)+(Zm(t)−Zm(t−1))

In this way, the position at the future time t+1 can be predicted from the measured values of the positions at time t−1 and time t (that is, time-series data of the positions) using the linear prediction method.

As described above, according to the embodiments of the invention, in data transmission via the network N with a transmission latency, the data prediction device predicts future data after a lapse of a prediction time equivalent to a latency time on a transmission line of the network N. This makes it possible to realize transmission with almost zero latency time between transmitting and receiving ends.

Especially in the remote control system 600 shown in FIG. 6, by using not only the operating information of the controller 602a but also the electromyographic information of the operator to predict operating information, it is possible to improve the accuracy of start in the operating information.

The following non-patent literature reveals that, in vehicle remote control, a latency time on a transmission line up to 600 msec does not significantly affect a steering maneuver, whereas an actual vehicle trajectory greatly deviates from an intended trajectory when the latency time exceeds 600 msec. By using the data prediction methods according to the embodiments, reduction from an actual latency time by about 500 msec can be expected. Therefore, even when the latency time exceeds 600 msec, the operation can be performed more accurately than ever before.
Kazuhisa Mizushima, Takahisa Kamikura, Manabu Omae, “Evaluation of Influence of Delay of Image Information on Steering Maneuver in Remotely Controllable Automated Driving System,” Transactions of Society of Automotive Engineers of Japan, Vol. 50, No. 3, 2019. (in Japanese)

The invention is not limited to the above-described embodiments, and various modifications can be made without departing from the scope of the invention. Other embodiments and variations made by those skilled in the art are intended to be embraced within the scope of the invention.

### REFERENCE SIGN LIST

100, 200: data transmission system
102, 202: transmitting device
104, 204, 504, 604: data prediction device
105: neural network
108, 208: receiving device
210: latency time detection device
212: table
500, 600: remote control system
502, 602a: controller
602b: electromyography sensor
508, 608: machine
N: network
OP: operator

1. A method for transmitting data via a network with a transmission latency, the method comprising:
sequentially transmitting data by a transmitting device;
predicting future data after a lapse of a prediction time equivalent to a latency time on a transmission line of the network based on time-series data in a given period transmitted from the transmitting device, by a data prediction device using a prescribed prediction method;
transmitting the future data by the data prediction device; and
receiving the future data by a receiving device.

2. The method according to claim 1, wherein
trained parameters are stored in the data prediction device, the trained parameters being obtained by training a plurality of data sets each having time-series data for training in the given period and future data for training after a lapse of the prediction time, and
predicting the future data by the data prediction device is performed based on the trained parameters and the time-series data in the given period transmitted from the transmitting device.

3. The method according to claim 1, further comprising:
training, for a plurality of different latency times, a plurality of data sets each having time-series data for training in the given period and future data for training after a lapse of the prediction time to obtain trained parameters by the data prediction device;
storing the trained parameters in a table by the data prediction device;
detecting the latency time on the network by a latency time detection device; and
reading out, by the data prediction device, a trained parameter from the table corresponding to the latency time detected by the latency time detection device, wherein
predicting the future data by the data prediction device is performed based on the trained parameter read out from the table and the time-series data in the given period transmitted from the transmitting device.

4. The method according to claim 1, comprising:
sequentially transmitting, by the transmitting device, operating information of a controller for operating a machine in a remote location via the network;
predicting, by the data prediction device, future operating information after a lapse of the prediction time based on the time-series data of the operating information of the controller in the given period; and
transmitting, by the data prediction device, the future operating information to the machine as the receiving device, wherein
the machine operates in accordance with the future operating information.

5. The method according to claim 4, comprising:
sequentially transmitting, by the transmitting device, electromyographic information of an operator who operates the controller from an electromyography sensor attached to the operator, in addition to the operating information of the controller, wherein
predicting the future operating information by the data prediction device is performed based on the time-series data of the operating information in the given period and the time-series data of the electromyographic information in the given period.

6. A system for transmitting data via a network with a transmission latency, the system comprising:
a transmitting device configured to sequentially transmit data;
a data prediction device configured to predict future data after a lapse of a prediction time equivalent to a latency time on a transmission line of the network based on time-series data in a given period transmitted from the transmitting device, using a prescribed prediction method, and transmit the future data; and
a receiving device configured to receive the future data.

7. The system according to claim 6, wherein
the data prediction device is configured to:
store trained parameters obtained by training a plurality of data sets each having time-series data for training in the given period and future data for training after a lapse of the prediction time; and
predict the future data based on the trained parameters and the time-series data in the given period transmitted from the transmitting device.

8. The system according to claim 6, further comprising:
a table configured to store trained parameters obtained by training, for a plurality of different latency times, a plurality of data sets each having time-series data for training in the given period and future data for training after a lapse of the prediction time; and
a latency time detection device configured to detect the latency time on the network, wherein
the data prediction device is configured to:
read out a trained parameter from the table corresponding to the latency time detected by the latency time detection device; and
predict the future data based on the trained parameter read out from the table and the time-series data in the given period transmitted from the transmitting device.

9. The system according to claim 6, wherein
the transmitting device is configured to sequentially transmit operating information of a controller for operating a machine in a remote location via the network,
the data prediction device is configured to predict future operating information after a lapse of the prediction time based on the time-series data of the operating information of the controller in the given period, and transmit the future operating information to the machine as the receiving device, and
the machine is configured to operate in accordance with the future operating information.

10. The system according to claim 9, wherein
the transmitting device is configured to sequentially transmit electromyographic information of an operator who operates the controller from an electromyography sensor attached to the operator, in addition to the operating information of the controller, and
the data prediction device is configured to predict the future operating information based on the time-series data of the operating information in the given period and the time-series data of the electromyographic information in the given period.
